(19) United States
(12) Patent Application Publication
(10) Pub. No.: US 2006/0103784 A1
(43) Pub. Date: May 18, 2006

(54) Chromatic flexible display with a wide viewing angle and method for manufacturing the same

(76) Inventors: Kang-Hung Liu, Tao Yuan Hsien (TW); Chi-Chang Liao, Tai Nan City (TW); Lung-Pin Hsin, Tai Chung City (TW); Ku-Hsien Chang, Kao Hsiung Hsien (TW)

Correspondence Address: RABIN & BERDO, P.C., Suite 500, 1101 14 Street, N.W., Washington, DC, 20005, US

(21) Appl. No.: 11/272,137

(22) Filed: Nov. 14, 2005

(30) Foreign Application Priority Data
Nov. 12, 2004 (TW) 93134841

(51) Int. Cl. G02F 1/1335

(52) U.S. Cl. 349/106

(57) ABSTRACT

A chromatic flexible display with a wide viewing angle and a method for manufacturing the same are proposed. The present invention provides a wide-angle structure for a chromatic flexible display and a corresponding manufacturing method. Due to the arrangement of the microstructures of the upper plastic base plate and the lower plastic base plate, the colorization is improved and the viewing angle is widened and has multiple divisions. In this way, the chromatic flexible display provided in the present invention is convenient for mass production and displays a high-quality image with a wide viewing angle.

### BACKGROUND OF THE INVENTION

1. Field of the Invention

The present invention is related to a chromatic flexible display with a wide viewing angle and a method for manufacturing the same, and more particularly, to a wide-angle flexible display and a manufacturing method that uses a microstructure formed on an upper plastic base plate and a lower plastic base plate for providing multiple divisions and colorization.

2. Description of Related Art

Although a liquid crystal display (LCD) has various advantages compared with a cathode ray tube (CRT) display, such as being compact and light, it has an obvious shortcoming. That is the viewing angle of an LCD is much smaller than that of a CRT display. In order to improve upon this shortcoming, various techniques for manufacturing LCDs have been developed, for example, the In Plane Switch (IPS) technique. However, compared with the conventional Twist Nematic (TN) technique, the light transmission rate of the IPS technique is very low. In order to widen the viewing angle of LCDs, another method usually used changes the orientation of molecules of liquid crystal so that the molecules have multiple orientations.

In order to manufacture an LCD with a wide viewing angle, an LCD with a multi-division structure has been proposed. In flat panel display technology, every pixel is divided into several divisions to compensate for the optical asymmetry and widen the viewing angle of the LCD. The outside of the LCD panel is adhered with a compensating film and an orthogonal polarization sheet, and the liquid crystal is divided into multiple divisions. This technology has the advantages of widening the viewing angle and lowing the dispersion rate. Furthermore, in the manufacturing process used in this technology, directional rubbing is prevented. Thus, static charges do not accumulate when this technology is applied.

In conventional technologies, Sipix proposed a “manufacturing process for electronphoretic display” in U.S. Pat. No. 6,672,921. This patent discloses a device and manufacturing method using a micro-cup array. Reference is made to FIG. 1, which is a schematic diagram showing the manufacturing process for an electronphoretic display. This method uses a roller molding process to provide the micro-cup structure of the electronphoretic display. However, this kind of manufacturing process is a little complicated.

In addition, the Electronics Research & Service Organization of Industrial Technology Research Institute (ITRI) has provided patents related to multi-division LCD, such as Taiwan Patent 440738, “multi-division LCD structure”. This patent discloses a multi-division LCD structure. Reference is made to FIG. 2, which is a schematic diagram of a cross-sectional structure of the multi-division LCD disclosed in this patent. This patent discloses a wall-bump structure formed in the center of the pixel that is provided on a color filter or a thin film transistor (TFT) base plate. Therein, the wall-bump structure provides a pretilted angle. Thereby, when an external electric field is provided, the liquid crystal molecules are arranged orderly to form multiple divisions with multiple orientations. Furthermore, the proportion of light transmitted up and down, or left and right, can be adjusted by changing the location of the wall-bump structure.

Accordingly, as discussed above, the prior art still has some drawbacks that could be improved upon. The present invention aims to resolve the drawbacks of the prior art.

### SUMMARY OF THE INVENTION

In order to improve the conventional wide-angle display technology, the inventor of this application proposes a chromatic flexible display with a wide viewing angle and a method for manufacturing the same.

An objective of the present invention is to provide a wide-angle structure for a chromatic flexible display and a corresponding manufacturing method. Via the arrangement of the microstructures for the upper and lower plastic base plates, colorization and a wide viewing angle with multiple divisions are achieved. In this way, the chromatic flexible display provided in the present invention is convenient for mass production and has a wide high-quality viewing angle.

For reaching the objective above, the present invention provides a method for manufacturing a chromatic flexible display with a wide viewing angle. It includes forming a first conductive layer on a first base plate; providing a microstructure with matrix architecture on the first conductive layer; forming a second conductive layer on a second base plate; providing a plurality of partitive walls on the second conductive layer; providing a color filter among the partitive walls; and infusing a liquid display medium below the color filter.

The present invention also provides a device made via the foresaid method.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram showing the manufacturing process for an electronphoretic display;

FIG. 2 is a schematic diagram of a cross-sectional structure for a conventional multi-division LCD;

FIG. 3 is a schematic diagram showing a cross-sectional structure for a chromatic flexible LCD with a wide viewing angle in accordance with the present invention;

FIG. 4 is a schematic diagram of a chromatic flexible display with a wide viewing angle in accordance with the present invention;

FIGS. 5a-c are schematic diagrams showing the first embodiment of the method for manufacturing a chromatic flexible display with a wide viewing angle in accordance with the present invention;

FIGS. 6a-c, are schematic diagrams showing the second embodiment of the method for manufacturing a chromatic flexible display with a wide viewing angle in accordance with the present invention;

FIGS. 7a-c are schematic diagrams showing the third embodiment of the method for manufacturing a chromatic flexible display with a wide viewing angle in accordance with the present invention;

FIGS. 8a-d are schematic diagrams showing the fourth embodiment of the method for manufacturing a chromatic flexible display with a wide viewing angle in accordance with the present invention; and

FIGS. 9a-d are schematic diagrams showing the fifth embodiment of the method for manufacturing a chromatic flexible display with a wide viewing angle in accordance with the present invention.

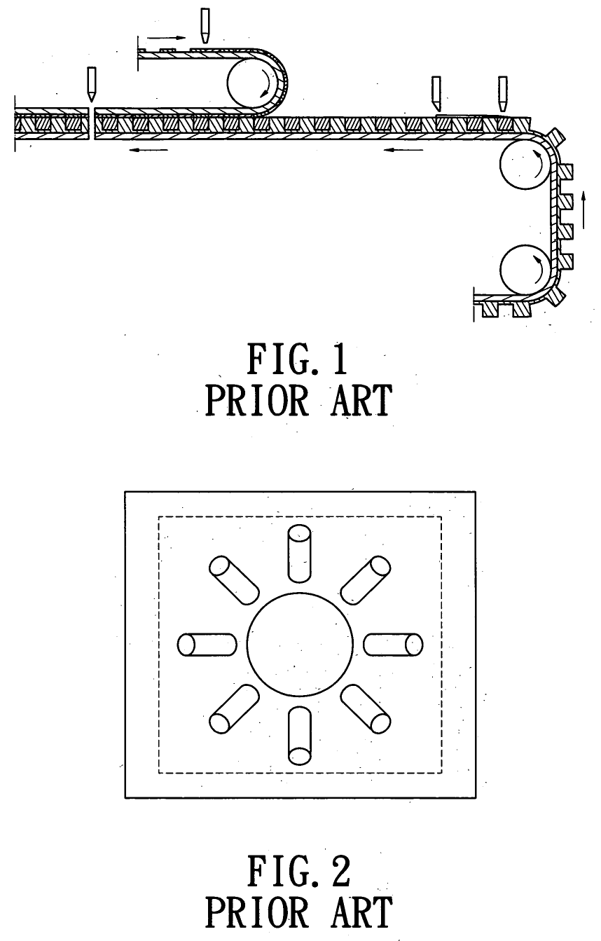

### DETAILED DESCRIPTION OF PREFERRED EMBODIMENTS

For consumers of high-level LCDs, colorization and wide viewing angle are the most important issues. With the advancement of flexible LCD technology, the transition from monochromatic displays to chromatic displays, which may be further combined with high-quality display technology for widening the viewing angle, is more and more important. The foresaid flexible LCD made via the micro-cup molding method proposed by Sipix Company is convenient for mass production. However, the problem of the manufacturing process caused by the alignment of the polarization sheet on the LCD base plate is not resolved. Moreover, for high-level applications, the technologies for colorization and widening the viewing angle are not mentioned, either.

The present invention uses the Multi-domain Homeotropical Alignment (MHA) technology belonging to ITRI as a base and combines the microstructure molding technology of ITRI with the colorization technology of an Inject Color Filter to propose the technology for a chromatic flexible LCD with a wide viewing angle.

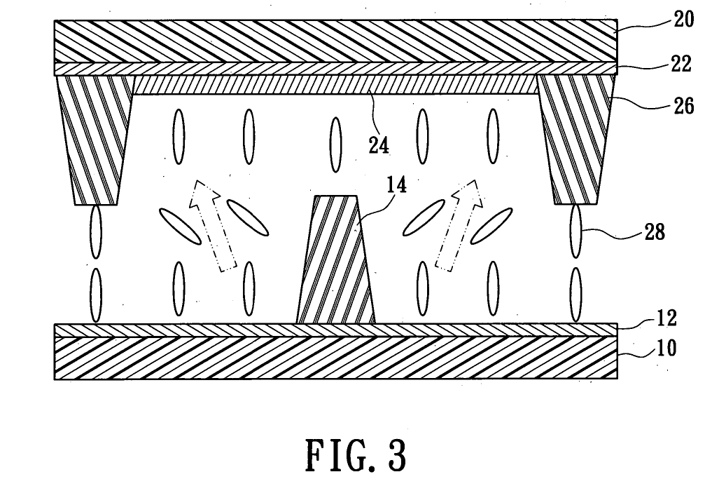

Reference is made to FIG. 3, which is a schematic diagram showing a cross-sectional structure of a chromatic flexible LCD with a wide viewing angle in accordance with the present invention. It shows a first base plate 10 (a flexible base plate), a second base plate 20 (a flexible base plate), a first conductive layer 12 (a transparent conductive layer) formed on the first base plate 10, a microstructure 14 with matrix architecture formed on the first conductive layer 12, a second conductive layer 22 (a transparent conductive layer) formed on the second base plate 20, multiple partitive walls 26 formed on the second conductive layer 22, a color filter 24 located among the partitive walls 26, and a liquid display medium 28 infused below the color filter 24.

Due to the microstructure 14 with the matrix architecture, the distribution of the electric field is not uniform. Hence, the viewing angle is widened. In addition, the foresaid partitive walls 26 are disposed against the second conductive layer 22 and the microstructure 14 hovers when implemented.

The method of the present invention for manufacturing a chromatic flexible display with a wide viewing angle includes: forming a first conductive layer 12 on a first base plate 10; providing a microstructure 14 with a matrix architecture on the first conductive layer 12, the microstructure 14 being formed via a molding, UV casting, printing, embossing or implementing a photo-lithography process; forming a second conductive layer 22 on the second base plate 20; providing multiple partitive walls 26 on the second conductive layer 22, these partitive walls 26 are formed via a molding, UV casting, printing, embossing or implementing a photo-lithography process, wherein these partitive walls 26 are formed with a matrix architecture with multiple divisions; providing a color filter 24 among the partitive walls 26, wherein the color filter 24 is formed via ink jet printing; and infusing a liquid display medium 28 below the color filter 24, wherein the liquid display medium 28 is produced by combining liquid crystal or combining electrophoresis with other macromolecules.

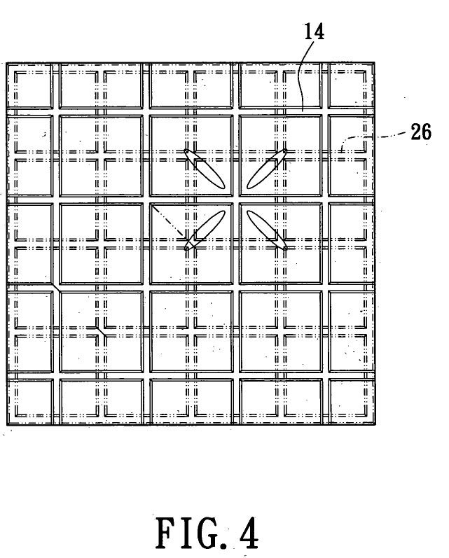

Reference is made to FIG. 4, which is a schematic diagram of a chromatic flexible display with a wide viewing angle in accordance with the present invention. Therein, the microstructure 14 and the partitive walls 26 are combined to form a liquid crystal gap and are stacked up. Because the liquid crystal gap is formed by the first and second base plates and has the functionality of column gaps to provide a gap for displaying images. Thus, the step for producing the column gaps can be omitted from the manufacture process.

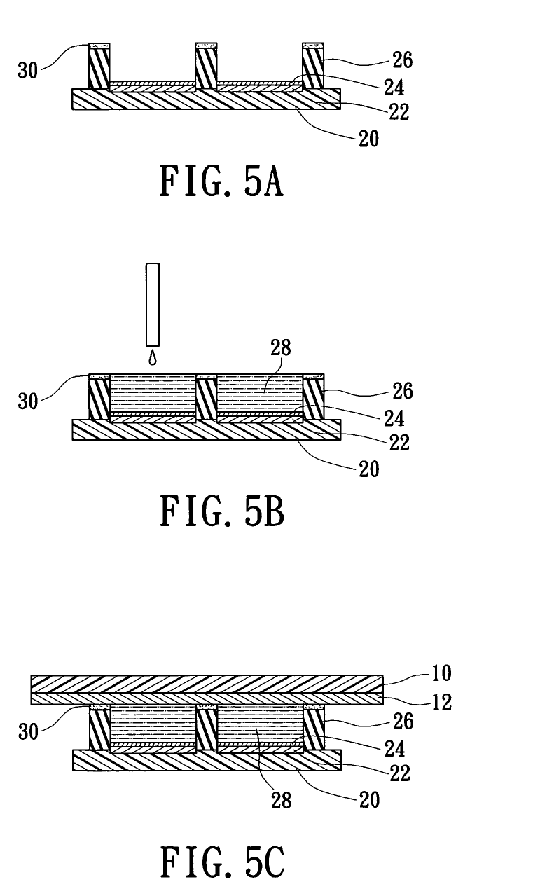

Reference is made to FIGS. 5a-c, which are schematic diagrams showing the first embodiment of the method for manufacturing a chromatic flexible display with a wide viewing angle in accordance with the present invention. In FIG. 5a, a second conductive layer 22 is formed on a second base plate 20 and multiple partitive walls 26 are provided on the second conductive layer 22. These partitive walls 26 are formed via a molding, UV casting, printing, embossing or photo-lithography process. These partitive walls 26 can be formed with a matrix architecture with multiple divisions. Furthermore, a color filter 24 is provided among the partitive walls 26 and is formed via ink jet printing. Then an adhesive material 30 is smeared on the surface of the partitive walls 26.

In FIG. 5b, a liquid display medium 28 is infused below the color filter 24. The liquid display medium 28 is produced by combining liquid crystal or combining electrophoresis with other macromolecules. Due to the different wavelengths of linearly polarized ultraviolet provided externally, the liquid display medium 28 forms multiple macromolecule columns (not shown) along or above the partitive walls or on the surface of the first conductive layer. In FIG. 5c, the first base plate 10 and the second base plate 20 are adhered together. The first base plate 10 has a first conductive layer 12 formed thereon. The adhering action is performed via heating (not shown).

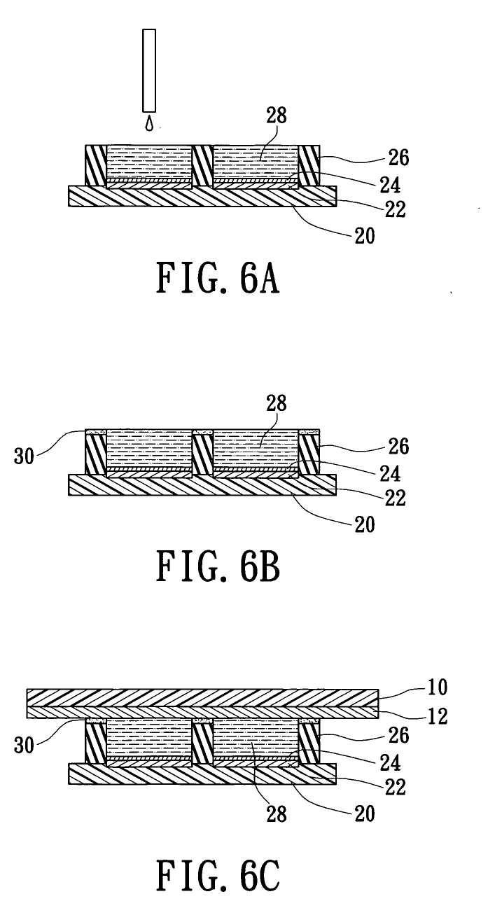

Reference is made to FIGS. 6a-c, which are schematic diagrams showing the second embodiment of the method for manufacturing a chromatic flexible display with a wide viewing angle in accordance with the present invention. In FIG. 6a, a second conductive layer 22 is formed on a second base plate 20 and multiple partitive walls 26 are provided on the second conductive layer 22. These partitive walls 26 are formed via a molding, UV casting, printing, embossing or photo-lithography process. These partitive walls 26 can be formed with a matrix architecture with multiple divisions. Furthermore, a color filter 24 is provided among the partitive walls 26 and is formed via ink jet printing. A liquid display medium 28 is infused below the color filter 24. The liquid display medium 28 is produced by combining liquid crystal or combining electrophoresis with other macromolecules. Due to the different wavelengths of linearly polarized ultraviolet provided externally, the liquid display medium 28 forms multiple macromolecule columns (not shown) along or above the partitive walls or on the surface of the first conductive layer.

In FIG. 6b, an adhesive material 30 is smeared on the surface of the partitive walls 26. In FIG. 6c, the first base plate 10 and the second base plate 20 are adhered together. The first base plate 10 has a first conductive layer 12 formed thereon. The adhering action is performed via heating (not shown).

The difference between the first and second embodiments is the step of smearing on the adhesive material. In the first embodiment an adhesive material is firstly smeared on the partitive walls and then the partitive walls are infused with the liquid display medium. In the second embodiment the step of infusing the liquid display medium into the partitive walls is performed first and then the adhesive material is smeared onto the partitive walls.

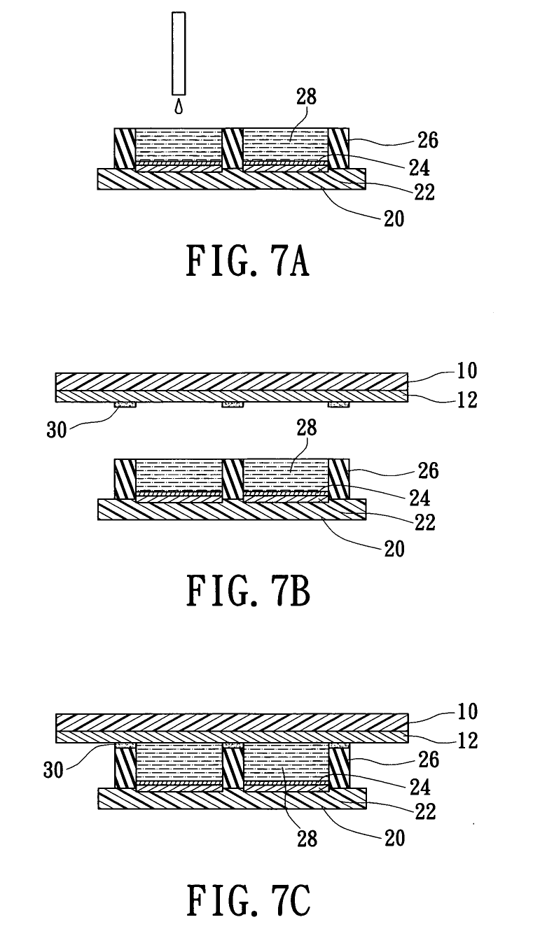

Reference is made to FIGS. 7a-c, which are schematic diagrams showing the third embodiment of the method for manufacturing a chromatic flexible display with a wide viewing angle in accordance with the present invention. In FIG. 7a, a second conductive layer 22 is formed on a second base plate 20 and multiple partitive walls 26 are provided on the second conductive layer 22. A color filter 24 is provided among the partitive walls 26 and is formed via ink jet printing. A liquid display medium 28 is infused below the color filter 24. The liquid display medium 28 is produced by combining liquid crystal or combining electrophoresis with other macromolecules. Due to the different wavelengths of linearly polarized ultraviolet light provided externally, the liquid display medium 28 forms multiple macromolecule columns (not shown) along or above the partitive walls or on the surface of the first conductive layer.

In FIG. 7b, the first base plate 10 has a first conductive layer 12 formed thereon. An adhesive material 30 is smeared on the proper areas of the first conductive layer 12 corresponding to the partitive walls 26. These partitive walls 26 are formed via a molding, UV casting, printing, embossing or photo-lithography process. These partitive walls 26 can be formed with a matrix architecture with multiple divisions. In FIG. 7c, the first base plate 10 and the second base plate 20 are adhered together. The adhering action is performed via heating (not shown).

The difference between the second embodiment and this one is the step of smearing the adhesive material. This embodiment first performs the step of infusing the liquid display medium and then smears the adhesive material on the proper areas of the first conductive layer 12 corresponding to the partitive walls 26.

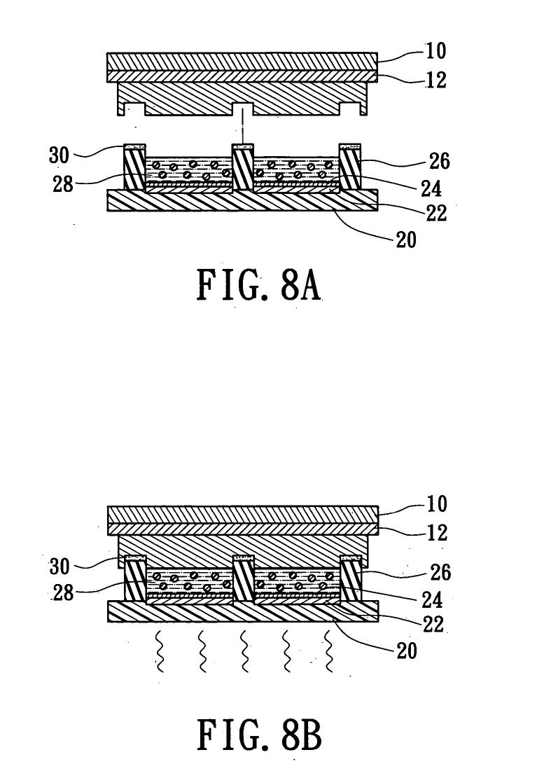

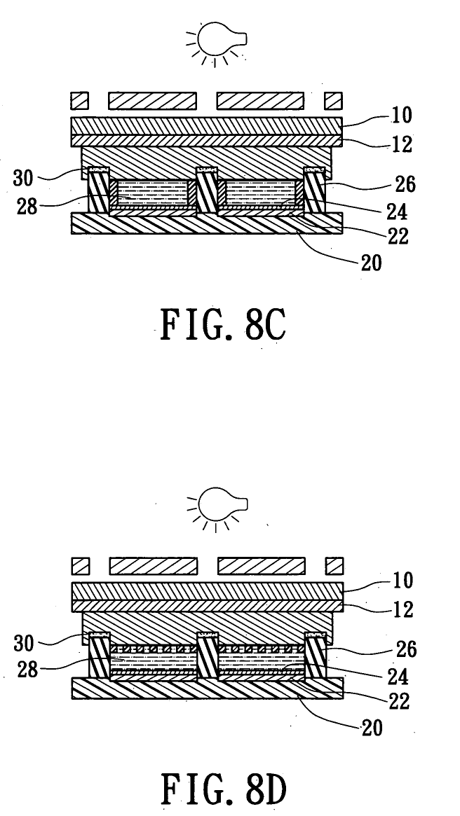

Reference is made to FIGS. 8a-d, which are schematic diagrams showing the fourth embodiment of the method for manufacturing a chromatic flexible display with a wide viewing angle in accordance with the present invention. In FIG. 8a, a first conductive layer 12 is formed on a first base plate 10 and multiple indentions are formed at the locations above the partitive walls 26. These partitive walls 26 are formed via a molding, UV casting, printing, embossing or photo-lithography process. These partitive walls 26 can be formed with a matrix architecture with multiple divisions.

A second conductive layer 22 is formed on a second base plate 20 and multiple partitive walls 26 are provided on the second conductive layer 22. A color filter 24 is provided among the partitive walls 26 and is formed via ink jet printing. A liquid display medium 28 is infused below the color filter 24. The liquid display medium 28 is produced by combining liquid crystal or combining electrophoresis with other macromolecules. An adhesive material is smeared on the surface of the partitive walls 26. In FIG. 8b, the first base plate 10 and the second base plate 20 are adhered together. The adhering action is performed via heating. Due to the different wavelengths of linearly polarized ultraviolet provided externally, the liquid display medium 28 forms multiple macromolecule columns along or above the partitive walls or on the surface of the first conductive layer (as shown in FIGS. 8c-d).

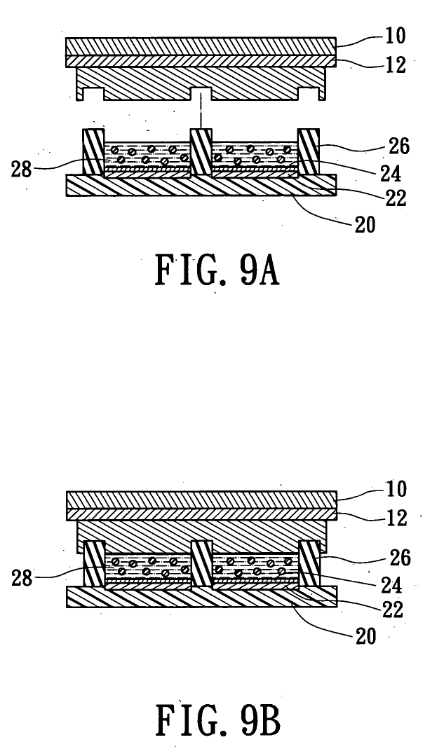

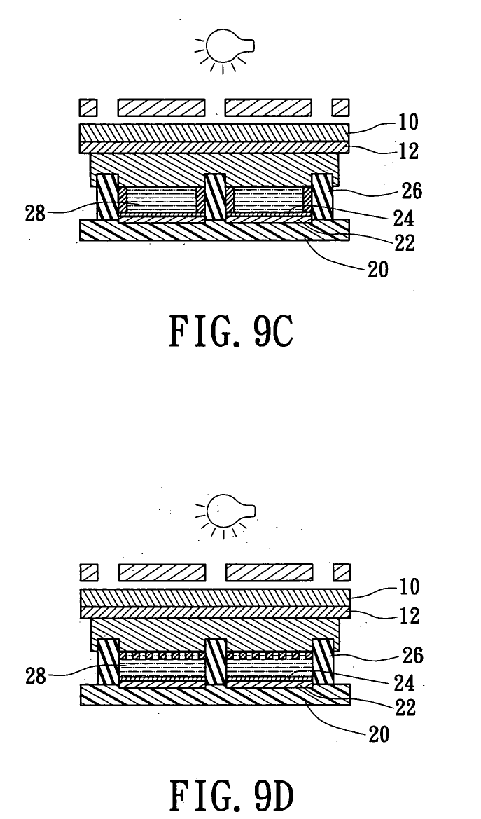

Reference is made to FIGS. 9a-d, which are schematic diagrams showing the fifth embodiment of the method for manufacturing a chromatic flexible display with a wide viewing angle in accordance with the present invention. In FIG. 9a, a first conductive layer 12 is formed on a first base plate 10 and multiple indentions are formed at the locations above the partitive walls 26. These partitive walls 26 are formed via a molding, UV casting, printing, embossing or photo-lithography process. These partitive walls 26 can be formed with a matrix architecture with multiple divisions.

A second conductive layer 22 is formed on a second base plate 20 and the partitive walls 26 are provided on the second conductive layer 22. A color filter 24 is provided among the partitive walls 26 and is formed via ink jet printing. A liquid display medium 28 is infused below the color filter 24. The liquid display medium 28 is produced by combining liquid crystal or combining electrophoresis with other macromolecules. In FIG. 9b, the first base plate 10 and the second base plate 20 are adhered together. The adhering action is performed via direct adhesion as shown in FIGS. 9a-b. Due to the different wavelengths of linearly polarized ultraviolet provided externally, the liquid display medium 28 forms multiple macromolecule columns along or above the partitive walls or on the surface of the first conductive layer (as shown in FIGS. 9c-d).

The present invention uses the partitive structure needed for the color filter formed by ink jet printing to provide the multiple divisions on the lower base plate. Next, the present invention uses a molding process to provide the same divisions on the upper base plate. After the two base plates are combined, the present invention can provide multiple divisions and widen the viewing angle. Since combining the structures of the multiple divisions of the upper and lower base plates forms a single uniform liquid crystal gap, it is not necessary to use spacers or photo spacers to provide a single liquid crystal gap. Thus, the present invention provides not only convenience of production but also excellent optical effects.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A method for manufacturing a chromatic flexible display with a wide viewing angle, comprising:
forming a first conductive layer on a first base plate;
providing a microstructure with a matrix architecture on the first conductive layer;
forming a second conductive layer on a second base plate;
providing a plurality of partitive walls on the second conductive layer;
providing a color filter among the partitive walls; and
infusing a liquid display medium below the color filter.

2. The method as claimed in claim 1, wherein the microstructure is formed via a molding, UV casting, printing, embossing or photo-lithography process.

3. The method as claimed in claim 1, wherein the partitive walls are formed via a molding, UV casting, printing, embossing or photo-lithography process and form a matrix architecture with multiple divisions.

4. The method as claimed in claim 1, wherein the color filter is formed via an ink jet printing process.

5. The method as claimed in claim 1, wherein the liquid display medium is provided by combining liquid crystal or electrophoresis with predetermined macromolecules.

6. A method for manufacturing a chromatic flexible display with a wide viewing angle, comprising:
forming a first conductive layer on a first base plate;
forming a second conductive layer on a second base plate;
providing a plurality of partitive walls on the second conductive layer;
providing a color filter among the partitive walls;
smearing an adhesive material on surfaces of the partitive walls;
infusing a liquid display medium below the color filter; and
adhering the first base plate on the second base plate.

7. The method as claimed in claim 6, wherein the partitive walls are formed via a molding, UV casting, printing, embossing or photo-lithography process and form a matrix architecture with multiple divisions.

8. The method as claimed in claim 6, wherein the color filter is formed via an ink jet printing process.

9. The method as claimed in claim 6, wherein the liquid display medium is provided by combining liquid crystal or electrophoresis with predetermined macromolecules.

10. The method as claimed in claim 6, wherein the step of adhering is performed by heating.

11. The method as claimed in claim 6, wherein the liquid display medium forms a plurality of macromolecule columns along or above the partitive walls or on a surface of the first conductive layer via exposure to a linearly polarized ultraviolet light provided externally.

12. A method for manufacturing a chromatic flexible display with a wide viewing angle, comprising:
forming a first conductive layer on a first base plate;
forming a second conductive layer on a second base plate;
providing a plurality of partitive walls on the second conductive layer;
providing a color filter among the partitive walls;
infusing a liquid display medium below the color filter;
smearing an adhesive material on surfaces of the partitive walls; and
adhering the first base plate onto the second base plate.

13. The method as claimed in claim 12, wherein the partitive walls are formed via a molding, UV casting, printing, embossing or photo-lithography process and form a matrix architecture with multiple divisions.

14. The method as claimed in claim 12, wherein the color filter is formed via an ink jet printing process.

15. The method as claimed in claim 12, wherein the liquid display medium is provided by combining liquid crystal or electrophoresis with predetermined macromolecules.

16. The method as claimed in claim 12, wherein the step of adhering is performed by heating.

17. The method as claimed in claim 12, wherein the liquid display medium forms a plurality of macromolecule columns along or above the partitive walls or on a surface of the first conductive layer via exposure to a linearly polarized ultraviolet light provided externally.

18. A method for manufacturing a chromatic flexible display with a wide viewing angle, comprising:
forming a first conductive layer on a first base plate;
smearing an adhesive material on predetermined areas of the first base plate corresponding to a plurality of partitive walls;
forming a second conductive layer on a second base plate;
providing the partitive walls on the second conductive layer;
providing a color filter among the partitive walls;
infusing a liquid display medium below the color filter;
smearing an adhesive material on surfaces of the partitive walls; and
adhering the first base plate onto the second base plate.

19. The method as claimed in claim 18, wherein the partitive walls are formed via a molding, UV casting, printing, embossing or photo-lithography process and form a matrix architecture with multiple divisions.

20. The method as claimed in claim 18, wherein the color filter is formed via an ink jet printing process.

21. The method as claimed in claim 18, wherein the liquid display medium is provided by combining liquid crystal or electrophoresis with predetermined macromolecules.

22. The method as claimed in claim 18, wherein the step of adhering is performed by heating.

23. The method as claimed in claim 18, wherein the liquid display medium forms a plurality of macromolecule columns along or above the partitive walls or on a surface of the first conductive layer via exposure to a linearly polarized ultraviolet light provided externally.

24. A method for manufacturing a chromatic flexible display with a wide viewing angle, comprising:
forming a first conductive layer on a first base plate;
providing a plurality of indentations on predetermined locations corresponding to a plurality of partitive walls;
forming a second conductive layer on a second base plate;
providing the partitive walls on the second conductive layer;
providing a color filter among the partitive walls;
infusing a liquid display medium below the color filter;
smearing an adhesive material on surfaces of the partitive walls; and
adhering the first base plate on the second base plate.

25. The method as claimed in claim 24, wherein the partitive walls are formed via a molding, UV casting, printing, embossing or photo-lithography process and form a matrix architecture with multiple divisions.

26. The method as claimed in claim 24, wherein the color filter is formed via an ink jet printing process.

27. The method as claimed in claim 24, wherein the liquid display medium is provided by combining liquid crystal or electrophoresis with predetermined macromolecules.

28. The method as claimed in claim 24, wherein the step of adhering is performed by heating.

29. The method as claimed in claim 24, wherein the liquid display medium forms a plurality of macromolecule columns along or above the partitive walls or on a surface of the first conductive layer via exposure to a linearly polarized ultraviolet light provided externally.

30. A method for manufacturing a chromatic flexible display with a wide viewing angle, comprising:
forming a first conductive layer on a first base plate;
providing a plurality of indentations on predetermined locations corresponding to a plurality of partitive walls;
forming a second conductive layer on a second base plate;
providing the partitive walls on the second conductive layer;
providing a color filter among the partitive walls;
infusing a liquid display medium below the color filter; and
adhering the first base plate onto the second base plate.

31. The method as claimed in claim 30, wherein the partitive walls are formed via a molding, UV casting, printing, embossing or photo-lithography process and form a matrix architecture with multiple divisions.

32. The method as claimed in claim 30, wherein the color filter is formed via an ink jet printing process.

33. The method as claimed in claim 30, wherein the liquid display medium is provided by combining liquid crystal or electrophoresis with predetermined macromolecules.

34. The method as claimed in claim 30, wherein the step of adhering is performed by heating.

35. The method as claimed in claim 30, wherein the liquid display medium forms a plurality of macromolecule columns along or above the partitive walls or on a surface of the first conductive layer via exposure to a linearly polarized ultraviolet light provided externally.

36. A chromatic flexible display, comprising:
a first base plate;
a second base plate;
a first conductive layer formed on the first base plate;
a microstructure with a matrix architecture formed on the first conductive layer;
a second conductive layer formed on the second base plate;
a plurality of partitive walls formed on the second conductive layer;
a color filter provided among the partitive walls; and
a liquid display medium infused below the color filter.

37. The chromatic flexible display as claimed in claim 36, wherein the first base plate and the second base plate are flexible base plates.

38. The chromatic flexible display as claimed in claim 36, wherein the first conductive layer and the second conductive layer are transparent conductive layers.
